(19) United States
(12) Patent Application Publication
(10) Pub. No.: US 2018/0183815 A1
(43) Pub. Date: Jun. 28, 2018

(54) SYSTEM AND METHOD FOR DETECTING MALWARE

(71) Applicant: Kerry Wayne Enfinger, Lake Worth, FL (US)

(72) Inventor: Kerry Wayne Enfinger, Lake Worth, FL (US)

(21) Appl. No.: 15/784,982

(22) Filed: Oct. 16, 2017

Related U.S. Application Data
(60) Provisional application No. 62/409,029, filed on Oct. 17, 2016.

(51) Int. Cl. H04L 29/06; G06N 99/00

(52) U.S. Cl. CPC H04L 63/145; G06N 99/005

(57) ABSTRACT

A system and method for detecting malware. The system and method is designed to detect malware without the requirement of malware signatures. The process relies upon converting a binary code file to an image. One or more machine learning techniques are used to classify the code as benign or malicious software.

### CROSS REFERENCE

In accordance with 37 C.F.R. 1.76, a claim of priority is included in an Application Data Sheet filed concurrently herewith. Accordingly, the present invention claims priority to U.S. Provisional Patent Application No. 62/409,029, entitled “SYSTEM AND METHOD FOR DETECTING MALWARE”, filed on Oct. 17, 2016. The contents of the above referenced application are herein incorporated by reference in its entirety.

### FIELD OF THE INVENTION

The present invention relates to systems and methods identifying malicious software in computers and computer systems; to information processing and security; and more particularly, to a system and method using machine learning classification for detecting malware in computer file images.

### BACKGROUND OF THE INVENTION

For many in modern society, use of computers for daily functioning is critical. Originally, computers were used primarily for business purposes. However, with great strides in technology over the last 20 years, computer usage touches all aspects of human life, including personal usage for watching movies, personal consumer transactions and other financial dealings, searching for information, completing school work, etc. With the increase in Internet usage, computer usage increases dramatically and in unpredictable ways. In addition, the development and use of smart phones or tablets, laptops, and other wireless devices further drives the use and need for computers. While computers bring great benefits to users, increased reliance on such devices is not without peril.

Most people understand the risk of not safeguarding one's own personal computer. In such case, one risks direct access to the contents of the computer by a stranger viewing the contents, thereby exposing sensitive files or personal information. A far more serious threat facing the computer industry is the rise in malicious software. Malicious software can be designed to provide a mechanism for individuals to perform harmless pranks. These actions, while troublesome or problematic to the end user, generally do not cause financial harm. More of a concern is the malicious software designed to provide sinister actions, such as money diversion, ransom threats, or theft of data. The threats associated with malicious software most often come in the form of viruses or worms targeting specific malicious actions within the operating system. Virus or worm threats from malicious code continue to compromise information security and are a major threat to commerce. Given the widespread usage and reliance on computers, and the ease at which criminals can use such software to enhance their criminal activities without being caught, increases in the development and use of malicious software are only expected to rise.

The number of malicious files present in the public domain continues to rise at a substantial rate, with a 3.17% increase during the 12-month period from 2013-2014 (Kaspersky. (2014a). Kaspersky Lab is Detecting 325,000 new malicious files every day. Retrieved from www.kaspersky.com). With each new malware creation and deployment, the computer user is at greater risk of malware infection and breach of information security (Zhang, M., Raghunathan, A., & Jha, N. K. (2014). A defense framework against malware and vulnerability exploits. International Journal of Information Security, 13(5), 439-452. doi:10.1007/s10207-014-0233-1). Non-targeted malware attacks increased by 26% in 2014 over the previous year with almost one million new threats released each day (Symantec. (2015). Internet Security Threat Report. Retrieved from www.symantec.com/security response/publications/threatreport.jsp). Targeted attacks, such as those used in Target Corporation's point-of-sales (POS) systems (Northcutt, S. (2014). Case study: Critical controls that could have prevented Target breach. Retrieved from www.sans.org/reading-room/whitepapers/casestudies/case-study-critical-controls-prevented-target-breach-35412), are now one of the biggest sources of data for stolen credit card information (Symantec, 2015). In order to defend the public against this increase, malicious software analysts must create a signature for each unique malware sample through the careful analysis of code within the malicious binary file under investigation (Afonso, V. M., de Amorim, M. F., Gregio, A. R. A., Junquera, G. B., & de Geus, P. L. (2014). Identifying Android malware using dynamically obtained features. Journal of Computer Virology and Hacking Techniques, 11(1), 9-17. doi:10.1007/s11416-014-0226-7). Creating signatures is helpful in combating known threats; however, small code changes made by software designers are effective in evading detection of signature-based detection methods. In addition, these small changes often render the signature useless in detecting new variations. Without effective means to detect new malware, computers are susceptible to new forms of malware and an increased likelihood of potential security breaches and financial damages. What is needed in the public and the information security field are new mechanisms to detect malicious software that rely on the static characteristics of binary files and not recognizing malware signatures.

Accordingly, there is a need for enhanced mechanisms to detect and eliminate the threat of malicious software.

### SUMMARY OF THE INVENTION

The present invention describes a system and method for detecting malware without requiring malware signatures. The process relies upon converting a binary code file to an image file. One or more machine learning techniques are then used to classify the suspected code as benign or malicious software.

As used herein, the term “Histogram of oriented gradients” (HOG) is defined as an image processing method that extracts feature descriptors from localized areas of the image, counting the gradient orientation of each.

As used herein, the term “Kernel” is defined as a mathematical algorithm used by the machine learning method to identify patterns in data by mapping representative data to higher dimensions. The higher dimensional space allows for more separation between data points and more accurate classification by the machine-learning model. Popular kernel algorithms include the Gaussian, polynomial, and linear kernel algorithms.

As used herein, the term “Linear kernel” is defined as a kernel algorithm that returns the dot product of two vectors (x, z).

As used herein, the term “Machine learning” is defined as the implementation of mathematical learning algorithms in a computer application for the automatic detection of patterns and features. Machine learning requires a specific task to perform, metrics for the machine learning performance, and sources of training data. Design choices in machine learning include the type of training method, a learning target function and its representation, and a learning algorithm for use in the training.

As used herein, the term “Nearest neighbor” is defined as a machine-learning model that uses distances between the key points of feature descriptors to match classification groups.

In an illustrative embodiment, the invention provides for a computer implemented method for detecting malware using non-executable file format, at least a portion of the method being performed by a computing device comprising at least one processor configured to provide file conversion of a suspect software to a graphic image, provide image processing and feature extraction, provide machine learning model selection, and provide malware classification.

In another illustrative embodiment, the invention includes a system for detecting or classifying malware using a non-executable file format comprising one or more processors; and memory storing instructions that, when executed by the one or more processors, cause the one or more processors to detect or classify malware using a non-executable file format located on a computer device; the detecting or classifying malware using a non-executable file format located on the computer device, and including receiving a portable executable file from a computer software in need of analysis; converting the portable executable file to a computer graphic image; processing the graphic image; and identifying the computer file as benign or malicious malware. The system may include one computer device or one or more computing devices linked together or linked to a server via a network, such as the internet. The system may further be adapted to allow the one or more processors to execute any of the functional components, features, or instructions described herein.

In another illustrative embodiment, the invention includes a non-transitory computer readable medium storing instructions comprising: instructions for detecting or classifying malware using a non-executable file format located on the computer device by: receiving a portable executable file from a computer software in need of analysis; converting the portable executable file to a computer graphic image; processing the graphic image; and identifying said computer file as benign software or malicious malware. The non-transitory computer readable medium storing instructions may further be adapted to allow for the execution of any of the functional components, features, or instructions described herein.

Accordingly, it is an objective of the invention to provide an improved system and method for detecting malware in computer file images.

It is an objective of the invention to provide an improved system and method for detecting malware that does not require recognition of malware signatures.

It is a further objective of the invention to provide a system which uses machine learning classification for detecting malware in computer file images.

It is yet another objective of the invention to provide a method for detecting malware in computer file images using machine learning classification.

It is a still further objective of the invention to provide a malware detection system that is resilient to code obfuscation, non-signature based, and adaptable to the discovery of unknown malware samples.

It is a further objective of the invention to provide a system which utilizes images to detect malware samples.

It is yet another objective of the invention to provide a method which utilizes images to detect malware samples.

It is a further objective of the invention to provide a system which utilizes non-signature based detection methods to classify malicious software by type or family.

It is yet another objective of the invention to provide a method which utilizes non-signature based detection mechanisms to classify malicious software by type or family.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is an illustrative embodiment of a method for detecting malware;

FIG. 2 is a block diagram of a system for detecting malware, in accordance with an embodiment of the present invention;

FIG. 3A is a block diagram of a component of the system for detecting malware;

FIG. 3B is a block diagram of the one or more software modules used for detecting or classifying malware;

FIG. 4 is a screenshot of the first stage of an analysis process;

FIGS. 5A-5F are illustrative examples of malware samples converted into a graphic image;

FIGS. 6A-6F are illustrative examples of image malware graphics with descriptors;

FIG. 7 is a table showing illustrative results from a Kappa test; and

FIG. 8 is an illustrative example of a receiver operating characteristic curve.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The number of malicious files present in the public domain continues to rise at a substantial rate. With each new malware creation and deployment, computer users are at greater risk of malware infection and breach of information security. Non-targeted malware attacks increased by 26% in 2014 over the previous year with almost one million new threats released each day (Symantec, 2015). Targeted attacks, such as those used in Target Corporation's point-of-sales (POS) systems (Northcutt, 2014), are now the biggest source of data for stolen credit card information (Symantec, 2015). In order to defend the public against the increased attacks, malicious software analysts must create a signature for each unique malware sample through the careful analysis of code within the malicious binary file under investigation (Afonso et al., 2014). However, by making small code changes, malicious software designers can evade detection of signature-based detection methods and render the signature useless in detecting new variations (Han, K. S., Lim, J. H., Kang, B., & Im, E. G. (2014). Malware analysis using visualized images and entropy graphs. International Journal of Information Security, 14(1), 1-14. doi:10.1007/s10207-014-0242-0; Zhang, M., Raghunathan, A., & Jha, N. K. (2014). A defense framework against malware and vulnerability exploits. International Journal of Information Security, 13(5), 439-452. doi:10.1007/s10207-014-0233-1).

A consequence of not investigating alternative methods of detecting malware occurrence include an increased workload on malware analysts, resulting in delays of malware signatures for use in detection (Han et al., 2014; Nataraj, L., Karthikeyan, S., Jacob, G., & Manjunath, B. S. (2011). Malware images: Visualization and automatic classification. Paper presented at the Proceedings of the 8th International Symposium on Visualization for Cyber Security, USA.). As a result, the delays leave computer users susceptible to new forms of malware and increase the likelihood of information insecurity (Barat, M., Prelipcean, D.-B., & Gavrilul, D. T. (2013). A study on common malware families evolution in 2012. Journal of Computer Virology and Hacking Techniques, 9(4), 171-178. doi:10.1007/s11416-013-0192-5). Both the public and the information security field need malicious software detection that relies on the static characteristics of binary files, and that no longer necessitates the need for malware signatures (Narudin, F. A., Feizollah, A., Anuar, N. B., & Gani, A. (2014). Evaluation of machine learning classifiers for mobile malware detection. Soft Computing. doi:10.1007/s00500-014-1511-6; Rieck, K., Trinius, P., Willems, C., & Holz, T. (2011). Automatic analysis of malware behavior using machine learning. Journal of Computer Security, 19, 639-668. doi:10.3233/JCS-2010-0410).

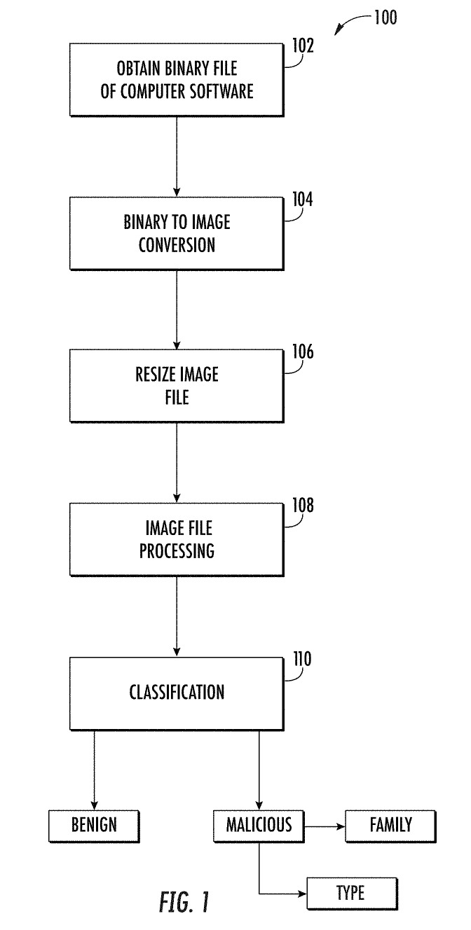

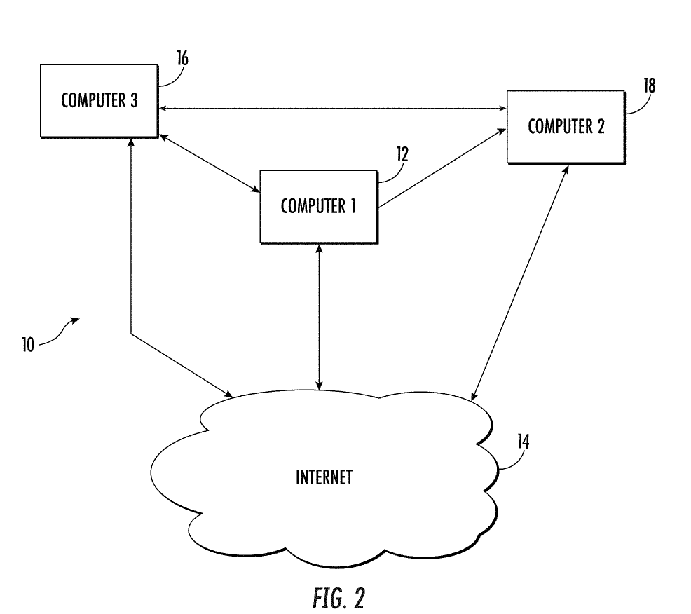

The present invention provides for a system and method that use one or more analysis modules which use one or more features of a suspect software to classify that suspect software as malicious or benign. The systems and methods are designed to provide detection and classification of the suspect software, which results in high detection rates and low false positive rates. FIG. 1 is an illustrative embodiment of a method for detecting malware, referred to generally as malware detection method 100. The malware detection system 100 is designed to analyze code in a computer system to determine if such code is benign or malicious. Upon a determination that the code is malicious, such code is further classified to help remove the threat. FIG. 2 illustrates an embodiment of a system utilizing or performing the illustrated method described in FIG. 1.

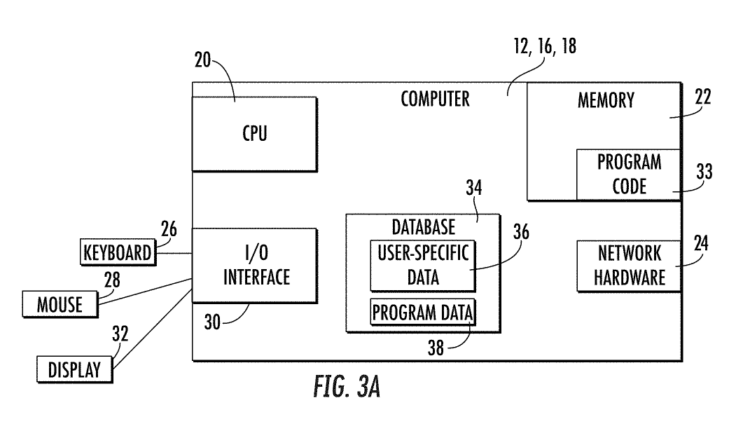

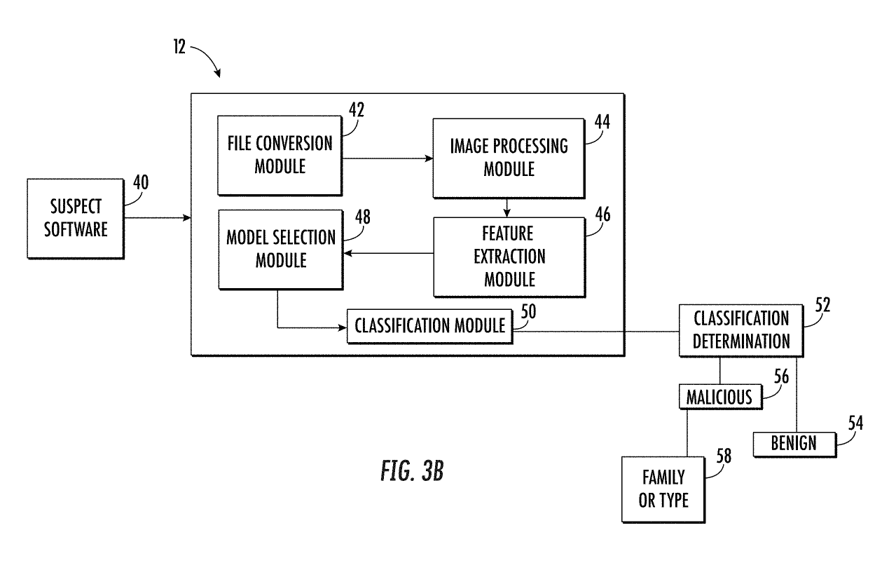

The malware detection system 10 includes at least one computer 12 configured to detect suspicious software or malware. The at least one computer 12 may be operatively connected to a network, such as the Internet 14. Additional computers 16 and 18 may be operatively connected to the at least one computer 12, the Internet 14, or each other. Any of the computers 12, 16, or 18 may include one or more central processing units (CPU(s)) 20 coupled to memory 22, and networking hardware 24, see FIG. 3A. The networking hardware 24 is operatively connected with the CPU(s) 20 such that the CPU (s) 20 can process network traffic inbound from the Internet 14 and deliver outbound network traffic to the Internet 4 utilizing, for example, a multi-layered networking protocol, such as TCP/IP. The CPU(s) 20 is preferably connected to input devices, such as a keyboard 26 or mouse 28 via an input/output interface 30. A display unit 32, such as an LCD screen, may be used to display any data output. The memory 22 may include both. volatile and non-volatile memory, and stores program code 33 executable by the one or more CPU(s) 20. The program code 33 causes the CPU(s) 20 to perform various steps that direct each computer 12, 16, or 18 to perform one or more embodiment methods for detecting malware. For each computer 12, 16, or 18, the program code 33 may reside permanent memory, such as on a hard disk, and then be loaded into non-volatile memory for execution, or may, for example, be obtained from a. remote server via the networking hardware 24 and then loaded into non-volatile memory for execution. Use of a computer database 34 for storing user-specific data 36 and/or a program. database 38 may also be envisioned, although persons of ordinary skill routinely make use of alternative strategies for storing data for use by a CPU 20.

The systems and methods described herein are designed to use modules, i.e. software/software programs and algorithms, designed to provide patterns and statistical analysis to properly determine and classify the computer software as malware. FIG. 3B illustrates a block diagram of the one or more software modules used for detecting or classifying computer software 40. The computer software 40 may be software located on the computer 12 or may be software obtained from a network, i.e. internet 14, website or server containing malware, or other computers 16, 18 linked to computer 12 via a network, such as via an email containing malware. Any suspect computer software 40 can be input to the one or more modules in order to determine if the computer software is malware and to classify the type of malware it is. Suspect computer software 40 is input and processed by one or more of the modules: file conversion module 42, image processing module 44, feature extraction module 46, model selection module 48, and classification module 50. The classification module 50 provides a classification function 52, to determine if the suspect software 40 is benign 54 or malicious 56. If the suspect software 40 is malicious 56, the classification module 50 can be used to determine the malware family or type 58.

Referring back to FIG. 1, a flow chart illustrating the process by which malware is detected without requiring malware signatures is illustrated. The process 100 provides for the use of non-executable file formats during detection in order to reduce the possibility of malware infection, and the lack of manual signature generation exponentially decreases the delay between database updates. Generally, the process 100 involves four steps: 1) File conversion to graphic image; 2) Image processing and feature extraction; 3) Machine learning model selection; and 4) Classification. The process begins by obtaining binary code of the suspect software, step 102. Next, a binary code is converted to an image, step 104. The conversion process uses a proprietary method of bitmap size reduction, while maintaining an accurate representation of the original image. The process uses an algorithm designed for comparing nearest-neighbor palletized values. In the initial stage of the binary-to-image file process, each section header is stripped from the original malware sample and all data sections are concatenated to a single array of bytes. The concatenated bytes are then resized and squared to a power of two, while stored in memory, to the desired image size (64×64 pixels), see step 106. The grayscale values of the pixels in the resized memory array are then adjusted using the original image color palette through the use of a proprietary nearest-color algorithm. The resulting image is written to digital storage medium and sent to the classification process. The imaged files are processed, see step 108, using one or more machine learning processes.

Based on the results of the one or more machine learning processes, the converted image is classified as a benign image or a malicious image, see step 110. In a preferred method, the software program utilized the HOG feature extraction method in combination with the k-nearest neighbor (KNN). The classification process begins with a computational determination of the suitability between the support vector machine (SVM) and KNN processes for maximum classification effects. The feature descriptors for the representative binary image are then extracted using the HOG feature extraction method and scaled to values which allow for optimal separation in multi-dimensional space. In the case of SVM, the optimal parameters of the radial kernel algorithm are estimated using the scaled feature descriptor. Finally, the process performs machine-learning classification using the resulting feature descriptors and determines classification of the malware sample as benign or malicious and, if malicious, the family and variant which has the closest relationship to the original sample.

If the image was determined to be malicious, i.e. determined to be code which disrupts computer operations, gathers sensitive information, gains access to private computer systems, or is a computer virus, worm, trojan horse, ransomware, spyware, adware, scareware, or other malicious program, the malware family or malware type was further classified.

The file conversion module 42 is computer software that converts the suspect computer software. The image processing module 44 provides computer software for file conversion to graphic image processing. In this first step, a portable executable file to be examined is converted to a computer graphics image. A portable executable file generally consists of a number of headers and sections which are organized as a linear stream of data. This process involves the reading of the file headers and separating the individual sections of the file, including, but not limited to 1) .data—section containing initialized file data; 2) .idata—section containing imported functions including the import directory and import address table; 3) .rsrc—section containing file resources such as icons and images; 4) .rdata—section containing the read-only data including strings and constants; 5) .edata—section containing the names and addresses of exported functions; and 6) .text—section containing the executable code of the file. While the header sections listed above may be specific to a portable executable format, other file types will have other relevant header information and characteristics. All available sections are combined into a single binary stream and converted to a bitmap image from the raw data. The conversion process includes reading each byte value of the binary stream and converting the byte value (0-255) to a corresponding grayscale color (0=black, 255=white). The image is then resized to a predetermined value (default of 64×64 pixels square) while retaining the highest color integrity from the original image color palette. While the above described 64×64 is preferable, each image can be sized to be both larger and smaller. The image should not be sized to be too small where any distinguishing features or aspects of the file cannot determined. The image should also not be sized too large where memory overload or processing overload occurs. The nearest color function utilizes an exponential mathematical formula to determine the Euclidean distance to the nearest matching palette color. This color is used in the final palette entry before the image is finalized. The feature extraction module 46 utilizes software and algorithms to extract representative values of each image for subsequent machine learning analysis. The feature extraction is computed utilizing the histogram of oriented gradients (HOG) feature descriptor. The HOG feature descriptors are then scaled to a preset minimum and maximum value for optimum spatial representation. The model selection module 48 is software that identifies the most efficient method of machine learning for utilization in the identification process. The machine learning models include both the support vector machine (SVM) and the k-nearest neighbor models (kNN). By default, the kNN model is used, as it has shown in empirical testing to have the largest significant effect on precision, recall, and F-measure (harmonic mean of precision and recall). Finally, the machine learning model is used to classify each test image as either benign or malicious, and categorize any malware in the appropriate family from the classification database. The classification module 50 uses software, database, or other analysis tools that provide a classification of the suspect software 40. The classification module 50 provides a classification determination 52 to determine if the suspect software 40 is benign 54 or malicious 56. If the suspect software 40 is malicious 56, the classification module 50 can be used to determine the malware family or type 58. The classification into family or type is based on determining the various characteristics of the suspect computer software 40 and comparing them to a database of known malware families and types which share similar characteristics, such as familial inclusion, payload type, and distribution methods.

Research Methods and Design

To test the effectiveness of the method for detecting malware using the above described method, a dataset of 10,853 malware samples of various malware families collected from a malicious software repository (VirusShare, 2015, Virussahre.com) was utilized. Millions of test cases for analysis were generated using over 10,000 malware samples. The HOG feature extraction method was shown superior in malware classification over the methods of BOW, GIST, SIFT and SURF with a classification accuracy of 97.22%. For the SVM machine-learning method, the radial kernel algorithm proved superior over the Gaussian, linear, and polynomial kernel algorithms, and performed most accurate with the HOG feature extraction method with a classification accuracy of 92.03%. The KNN classification method significantly outperformed the SVM classification method overall (the KNN method as high as 99.83% over 92.03% for the SVM method), but the SVM classification method may be more suitable for the classification of certain variants of malware.

### Example: Malware AdBundle

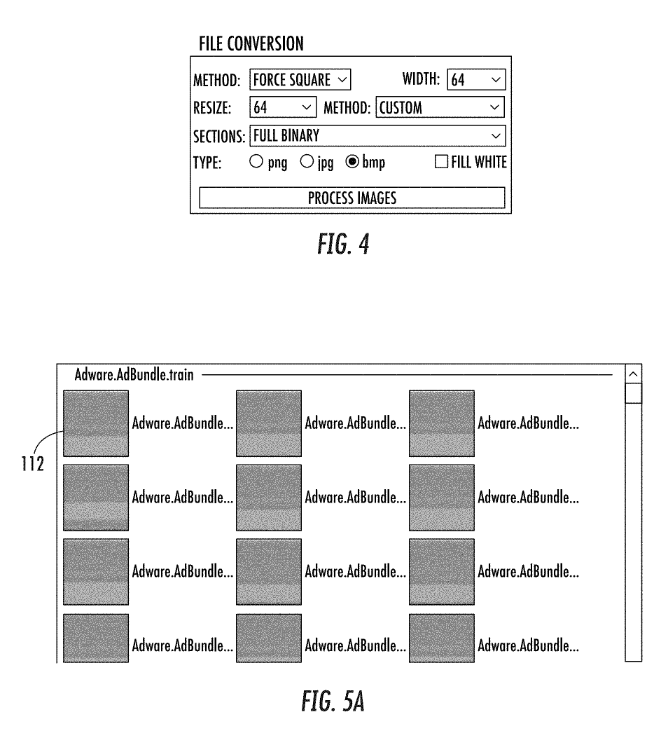

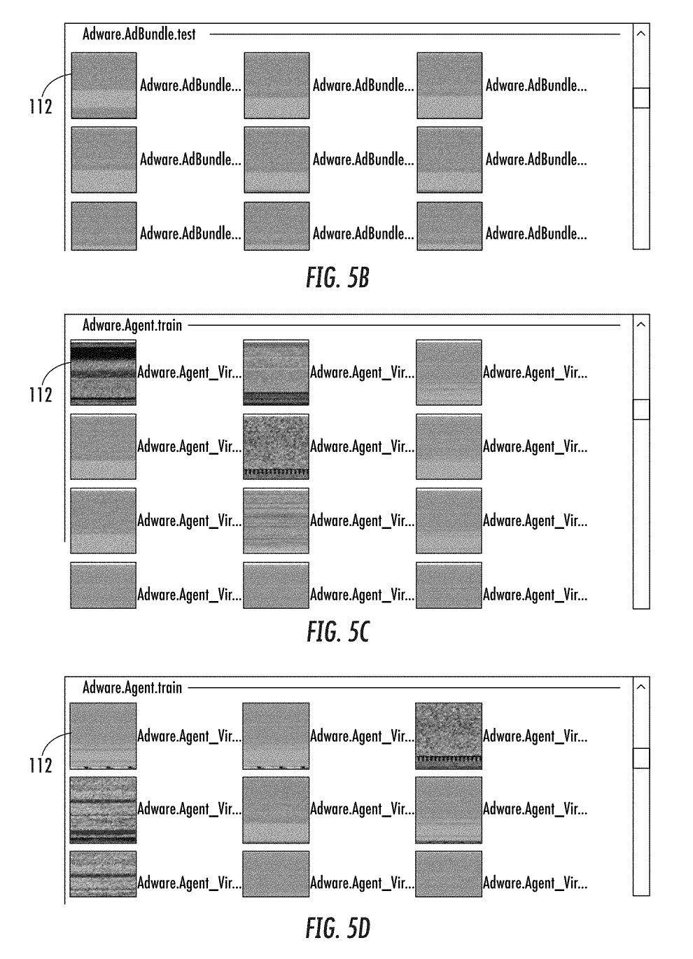

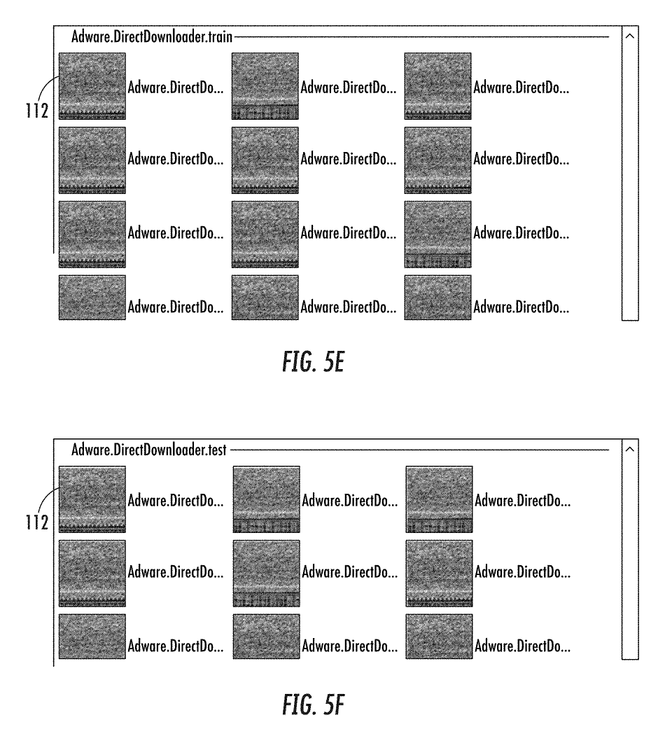

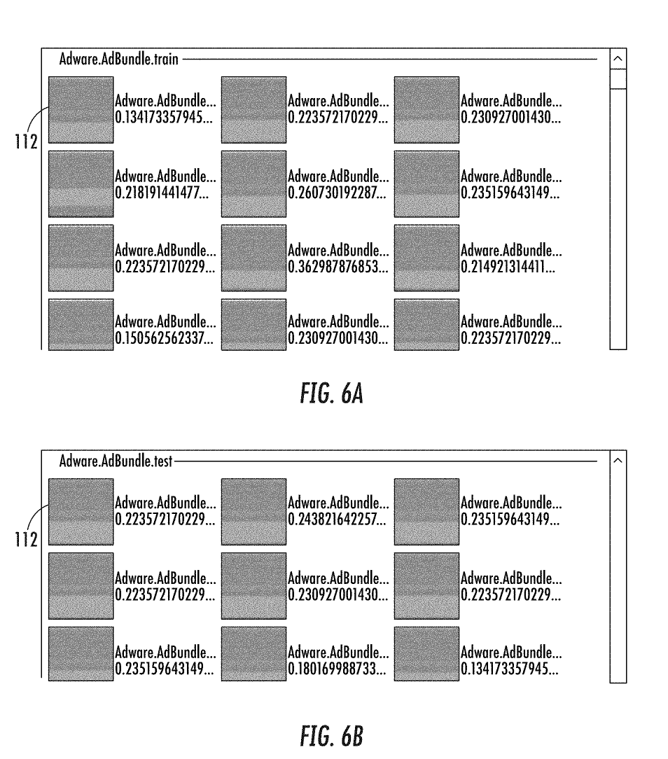

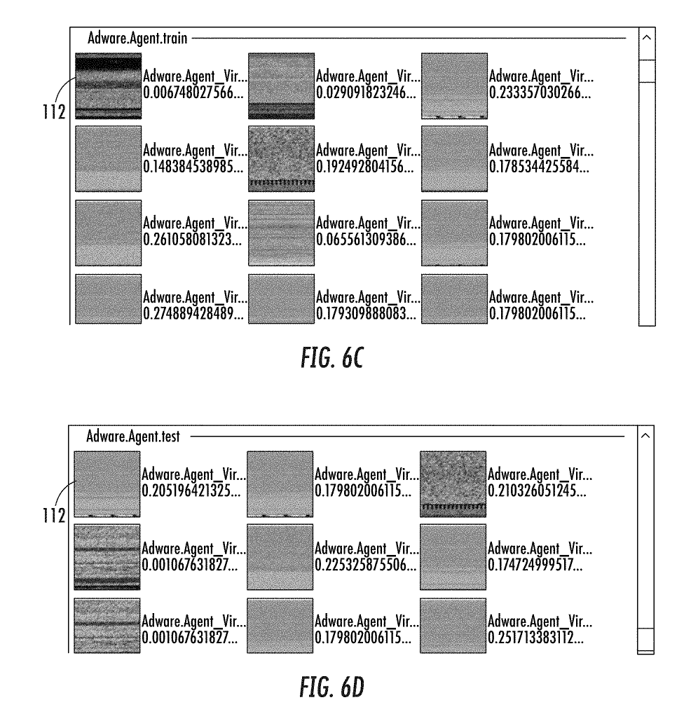

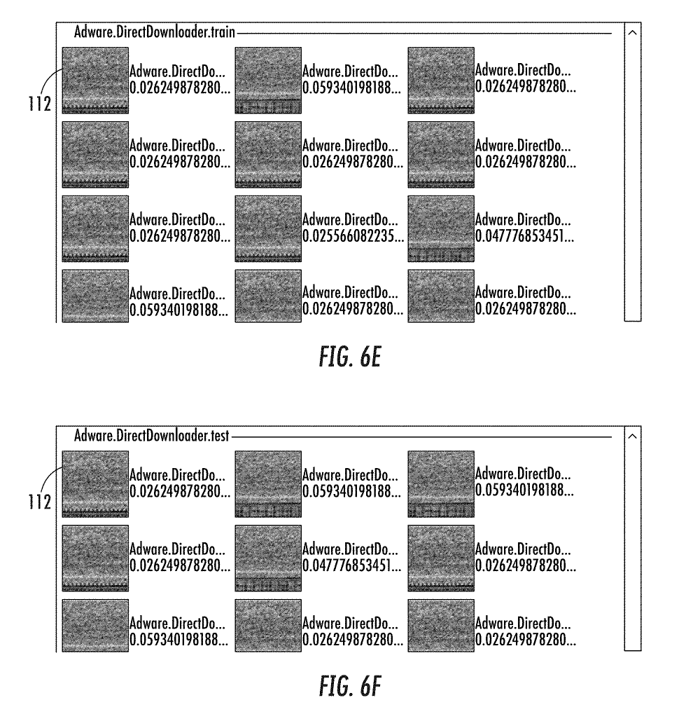

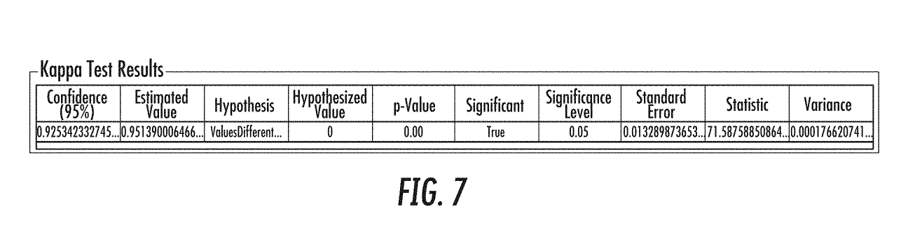

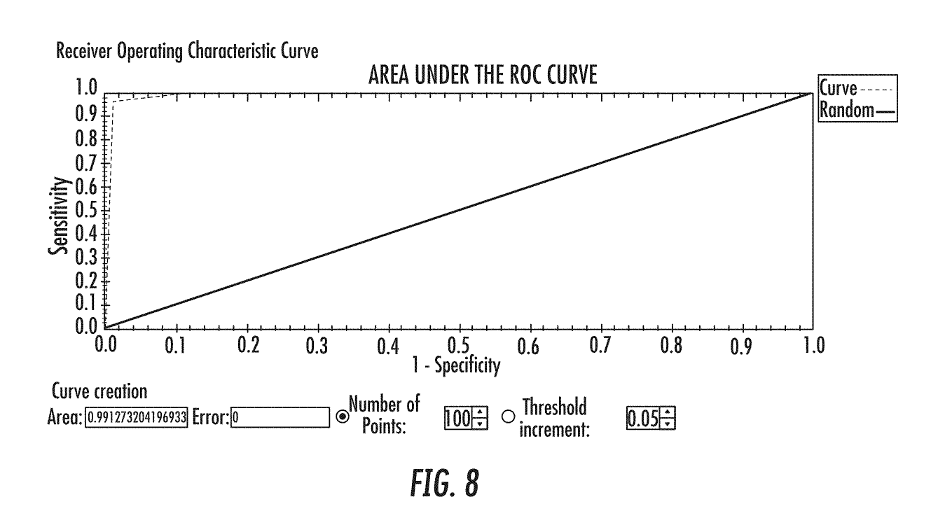

The following provides an illustrative analysis example, with screenshots for the manual processing of each stage of the analysis. The present invention can be adapted to provide a real-time process which automates all tasks and requires no input from the user. In the first step of the process, malware files are loaded into memory and divided between testing and training groups, with percentages of 70% for training and 30% for testing. Each malware sample is then converted, see FIG. 4 screen shot, into a graphic image file 12, see FIGS. 5A-5F. Each of the images are bit map representation of the binary file. Similar to fingerprints, each bit map representation generated is unique to the specific software to be analyzed. The black and white images are unique arraignments of ones and zeros that can be recognized by machine learning tools. A feature descriptor is generated for each malware image, see FIGS. 6A-6F, and scaled within a preset minimum and maximum range. In using a SVM classification method, the optimum kernel values are estimated utilizing the generated feature descriptors. In using a KNN classification method, feature descriptors are utilized without additional parameter adjustments. A Kappa test is performed to analyze the performance of the classification technique, see FIG. 7 for an illustrative Kappa test table. If accuracy is higher than a preset threshold, the analysis is deemed viable for proper malware detection. Classification accuracy can be determined through use of an ROC curve graph. In FIG. 8, the area under the ROC curve graph shows an extremely high classification accuracy of 99.13% of 898 samples in 9 malware classes using the present method. Feature descriptors may be stored in a database for later comparison to new malware samples. The feature descriptors include both malware family and variant for each tested malware sample.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of detecting malware using non-executable file format comprising the steps of:
receiving a portable executable file from a computer software in need of analysis;
converting said portable executable file to a computer graphic image;
processing said graphic image; and
identification of said computer file as benign or malicious malware.

2. The method for detecting malware using non-executable file format according to claim 1 wherein said portable executable file of a computer software in need of analysis is categorized into a malware family or malware type.

3. The method for detecting malware using non-executable file format according to claim 2 wherein at least a portion of said method being performed by a computing device comprising at least one processor.

4. The method for detecting malware using non-executable file format according to claim 1 wherein said portable executable file of a computer software in need of analysis is obtained from a network.

5. The method of detecting malware using non-executable file format according to claim 1 wherein said step of converting said portable executable file to a computer graphic image includes the step of reading of said portable executable file into a binary memory stream.

6. The method of detecting malware using non-executable file format according to claim 1 wherein said step of converting said portable executable file to a computer graphic image includes the step of extracting file headers, file header information, or combinations thereof, from said portable executable file.

7. The method of detecting malware using non-executable file format according to claim 1 wherein converting said portable executable file to a computer graphic image includes separating said binary memory stream into one or more individual sections.

8. The method of detecting malware using non-executable file format according to claim 7 wherein said one or more individual sections include .data section, .idata section, .rsrc section, .edta section, .text section, or combinations thereof.

9. The method of detecting malware using non-executable file format according to claim 7 wherein converting said portable executable file to a computer graphic image further including the steps of:
combining all said separated individual sections into a single binary stream; and
converting said single binary stream into a bitmap image.

10. The method of detecting malware using non-executable file format according to claim 9 wherein each byte value of said single binary stream is converted to a grayscale color value.

11. The method of detecting malware using non-executable file format according to claim 1 wherein said graphic image is resized to a pre-determined size.

12. The method of detecting malware using non-executable file format according to claim 1 wherein said processing said graphic image includes the step of feature extraction using histogram-of-orientated gradients feature descriptor.

13. The method of detecting malware using non-executable file format according to claim 1 wherein said identification of said computer file as benign or malicious malware comprises machine learning algorithms.

14. The method of detecting malware using non-executable file format according to claim 14 wherein said machine learning algorithms are based on support vector machine (SVM) or k-nearest neighbor (kNN).

15. A system for detecting or classifying malware using a non-executable file format comprising:
one or more processors; and
memory storing instructions that, when executed by said one or more processors, cause said one or more processors to detect or classify malware using a non-executable file format located on computer device;
said detecting or classifying malware using a non-executable file format located on computer device including
receiving a portable executable file from a computer software in need of analysis;
converting said portable executable file to a computer graphic image;
processing said graphic image; and
identifying said computer file as benign or malicious malware.

16. The system for detecting or classifying malware using a non-executable file format according to claim 15, wherein said computer device is linked to a second computer device or server through a network.

17. The system for detecting or classifying malware using a non-executable file format according to claim 16 wherein said at least one processor, when performing said step of converting said portable executable file to a computer graphic image, reads said portable executable file into a binary memory stream.

18. The system for detecting or classifying malware using a non-executable file format according to claim 16, wherein said at least one processor extracts file headers, file header information, or combinations thereof, from said portable executable file or separates said binary memory stream into one or more individual sections.

19. A non-transitory computer readable medium storing instructions comprising:
instructions for detecting or classifying malware using a non-executable file format located on computer device by:
receiving a portable executable file from a computer software in need of analysis;
converting said portable executable file to a computer graphic image;
processing said graphic image; and
identifying said computer file as benign software or malicious malware.
